(19) United States
(12) Patent Application Publication
(10) Pub. No.: US 2026/0296312 A1
(43) Pub. Date: Oct. 1, 2026

(54) VEHICLE DOOR MIRROR AND MANUFACTURING METHOD THEREFOR

(71) Applicant: Misato Industries Co., Ltd., Fujioka-shi (JP)

(72) Inventors: Takashi NAKATANI, Ebina-shi (JP); Tomoya MATSUBARA, Ebina-shi (JP)

(73) Assignee: Misato Industries Co., Ltd., Fujioka-shi (JP)

(21) Appl. No.: 19/478,345

(22) PCT Filed: Apr. 26, 2024
(86) PCT No.: PCT/JP2024/016388

§ 371 Date: Oct. 24, 2025

(30) Foreign Application Priority Data
Apr. 27, 2023 (JP) 2023-073782

(51) Int. Cl. B60R 1/06; B60R 1/12

(52) U.S. Cl. CPC B60R 1/06; B60R 1/12; B60R 2001/1253

(57) ABSTRACT

To eliminate or reduce the potential risk of falling of a closing part that closes an opening of a housing cover. A door mirror for a vehicle includes a lower cover that includes a shell portion having an outer surface and an inner surface and has at least one opening passing through the shell portion, and a closing part that closes the at least one opening from an inside of the lower cover.

### TECHNICAL FIELD

The present disclosure relates to a door mirror for a vehicle and a method of manufacturing the same, and more specifically relates to a door mirror including an optical device and a method of manufacturing the same.

### BACKGROUND ART

PTL 1 discloses that a camera and a lamp are assembled in a housing of a side mirror for a vehicle. As illustrated in FIG. 2 of PTL 1, a camera 50 and a lamp 60 are fixed with a common screw B.

PTL 2 discloses that a lamp is incorporated into a door mirror to provide foot lighting when an occupant gets in and out of a vehicle.

PTL 3 discloses that a projection device that projects a decorative light design onto an outer surface of a vehicle is incorporated into the vehicle.

### CITATION LIST

### Patent Literature

PTL 1: Japanese Unexamined Patent Application Publication No. 2016-78559.

PTL 2: Japanese Unexamined Patent Application Publication No. Hei 11-198717.

PTL 3: U.S. Pat. No. 7,175,321.

### SUMMARY OF THE INVENTION

### Problems to be Solved by the Invention

In some cases, a housing cover of a door mirror has an opening for a camera or a lamp. However, if no camera or lamp is mounted on the door mirror, the opening needs to be closed. Otherwise, a housing cover having no opening needs to be separately formed or molded. In addition to this point, when the opening of the housing cover is closed by a closing part, it is meaningful to consider the risk of falling of the closing part. For example, when the closing part falls off the door mirror while the vehicle is traveling, the falling of the closing part is highly likely to be unnoticed. If the door mirror is left as it is, the components incorporated in the door mirror are exposed to a severer environment. For example, while the vehicle is traveling, a wheel of the vehicle may fall into a puddle on a road surface and splash water into the door mirror.

As can be seen from the non-limiting example described above, the inventors of the present application have found a new task of eliminating or reducing the potential risk of falling of a closing part that closes an opening of a housing cover.

### Means for Solving the Problem

A first aspect of the present disclosure is a door mirror for a vehicle, the door mirror including: a housing cover that includes a shell portion having an outer surface and an inner surface and has at least one opening passing through the shell portion; and a closing part that closes the at least one opening from an inside of the housing cover.

A second aspect of the present disclosure is the door mirror according to the first aspect, wherein the closing part includes a closing portion that is at least partially disposed in the at least one opening to close the at least one opening, and first and second attached portions that are provided on both sides of the closing portion to sandwich the closing portion and are individually attached to first and second attaching portions of the housing cover.

A third aspect of the present disclosure is the door mirror according to the second aspect, wherein the first and second attached portions of the closing part are symmetrically shaped.

A fourth aspect of the present disclosure is the door mirror according to the second or third aspect, wherein the first and second attaching portions of the housing cover are symmetrically shaped.

A fifth aspect of the present disclosure is the door mirror according to any of the second to fourth aspects, wherein the shell portion has a peripheral edge portion that defines the at least one opening, and the closing portion has a sealing surface that is brought into contact with an inner surface of the peripheral edge portion on an entire circumference of the peripheral edge portion.

A sixth aspect of the present disclosure is the door mirror according to the fifth aspect, wherein the closing portion has a closing plate that is disposed in the at least one opening, and a sealing portion that protrudes from the closing plate and has the sealing surface.

A seventh aspect of the present disclosure is the door mirror according to any of the second to sixth aspects, wherein the closing portion has a recessed portion that is opened on a side opposite to the at least one opening, and a rib surrounding the recessed portion has at least one groove that allows fluid discharge from the recessed portion.

An eighth aspect of the present disclosure is the door mirror according to the seventh aspect, wherein the at least one groove includes two grooves that are symmetrically disposed.

A ninth aspect of the present disclosure is the door mirror according to any of the first to eighth aspects, wherein the closing part is attached to the housing cover by pivotally moving the closing part.

A tenth aspect of the present disclosure is the door mirror according to any of the second to eighth aspects, wherein the first attaching portion includes a pivotally supporting portion, the first attached portion includes a pivotally supported portion that is pivotally supported by the pivotally supporting portion, the second attached portion includes a turning portion that is turned during attachment of the closing part to the housing cover, and the turning portion has a locked portion that is locked by a locking portion of the second attaching portion.

An eleventh aspect of the present disclosure is the door mirror according to the tenth aspect, wherein the pivotally supported portion and the turning portion are disposed on a first axis to sandwich the closing portion and are symmetrically shaped with respect to the first axis.

A twelfth aspect of the present disclosure is the door mirror according to the tenth or eleventh aspect, wherein the pivotally supported portion includes a pivot axis portion in which a pair of locked ends protrude toward opposite sides on a pivot axis, and a connecting portion that extends between the closing portion and the pivot axis portion to connect the closing portion to the pivot axis portion.

A thirteenth aspect of the present disclosure is the door mirror according to the twelfth aspect, wherein the pivotally supporting portion includes a pair of pivotally supporting plates having cutouts that face an outside of the at least one opening in a radial direction, and the pivotally supported portion is pivotally supported by the pivotally supporting portion by insertion of the locked ends into the cutouts.

A fourteenth aspect of the present disclosure is the door mirror according to the twelfth or thirteenth aspect, wherein the connecting portion has a proximal end portion that is connected to the pivot axis portion and a distal end portion that is connected to the closing portion, and is bent at least at one position between the proximal end portion and the distal end portion.

A fifteenth aspect of the present disclosure is the door mirror according to the fourteenth aspect, wherein the connecting portion is bent at least at two positions between the proximal end portion and the distal end portion to have a U-shape.

A sixteenth aspect of the present disclosure is the door mirror according to any of the tenth to fifteenth aspects, wherein the second attaching portion has a cylinder portion that at least partially receives the locked portion.

A seventeenth aspect of the present disclosure is the door mirror according to any of the first to sixteenth aspects, wherein the housing cover has a camera attaching portion that is positioned around the at least one opening and to which a camera or a camera unit is attached.

An eighteenth aspect of the present disclosure is a method of manufacturing a door mirror, the method including attaching a closing part to a housing cover to close, from an inside of the housing cover, at least one opening formed on the housing cover.

A nineteenth aspect of the present disclosure is a method of manufacturing a door mirror for a vehicle, the method including: continuously forming a housing cover that includes at least one opening, a camera attaching portion, and a closing part attaching portion and in which the camera attaching portion and the closing part attaching portion are positioned around the at least one opening; attaching a camera, directly or via a bracket, to the camera attaching portion of a first housing cover obtained by the continuous forming of a housing cover; and attaching a closing part, from an inside of a second housing cover obtained by the continuous forming of a housing cover, to the closing part attaching portion of the second housing cover.

### Effect of the Invention

An aspect of the present disclosure can eliminate or reduce the potential risk of falling of a closing part that closes an opening of a housing cover.

### BRIEF DESCRIPTION OF THE DRAWINGS

FIG. 1 is a front view of a door mirror according to an aspect of the present disclosure, and also shows, by dotted lines, a camera and a lamp that are incorporated in the door mirror.

FIG. 2 is a rear view of the door mirror, and also shows, by dotted lines, the camera and the lamp that are incorporated in the door mirror.

FIG. 3 is a bottom view of the door mirror, and a lower cover of the door mirror has an opening for the camera and an opening for the lamp that are individually formed.

FIG. 4 is a schematic rear view of the lower cover that defines a housing space together with a mirror housing.

FIG. 5 is a schematic perspective view of the lower cover.

FIG. 6 is a schematic perspective view of the lower cover, and shows a state in which the camera is attached to the lower cover.

FIG. 7 is a schematic partially enlarged view of the lower cover, and shows a closing part attaching portion to which a closing part is attached.

FIG. 8 is a schematic cross-sectional view of the lower cover taken along the dot-dashed line VIII-VIII in FIG. 7.

FIG. 9 is a schematic perspective view of the lower cover while the closing part is attached to the lower cover.

FIG. 10 is a schematic cross-sectional view of the lower cover taken along the dot-dashed line X-X in FIG. 9.

FIG. 11 is a schematic perspective view of the closing part.

FIG. 12 is a schematic elevation view of the closing part, and shows an outer surface side of the closing part.

FIG. 13 is a schematic elevation view of the closing part, and shows an inner surface side of the closing part.

FIG. 14 is a schematic cross-sectional view of the closing part.

FIG. 15 is a process diagram illustrating a method of attaching the closing part to the closing part attaching portion.

FIG. 16 is a schematic diagram illustrating a closing part according to a modification.

### MODE FOR CARRYING OUT THE INVENTION

Non-limiting embodiments and features of the present invention will be described below with reference to the drawings. Those skilled in the art can combine embodiments and/or features without excessive description, and can understand the synergistic effects of the combination. Duplicate descriptions of the embodiments will be omitted in principle. The reference drawings are mainly intended to describe the invention, and are simplified for convenience of illustration. The features are effective not only for the door mirror and the method of manufacturing a door mirror that are disclosed in the present specification, but should be understood as universal features applicable to various other door mirrors and methods of manufacturing a door mirror that are not disclosed in the present specification.

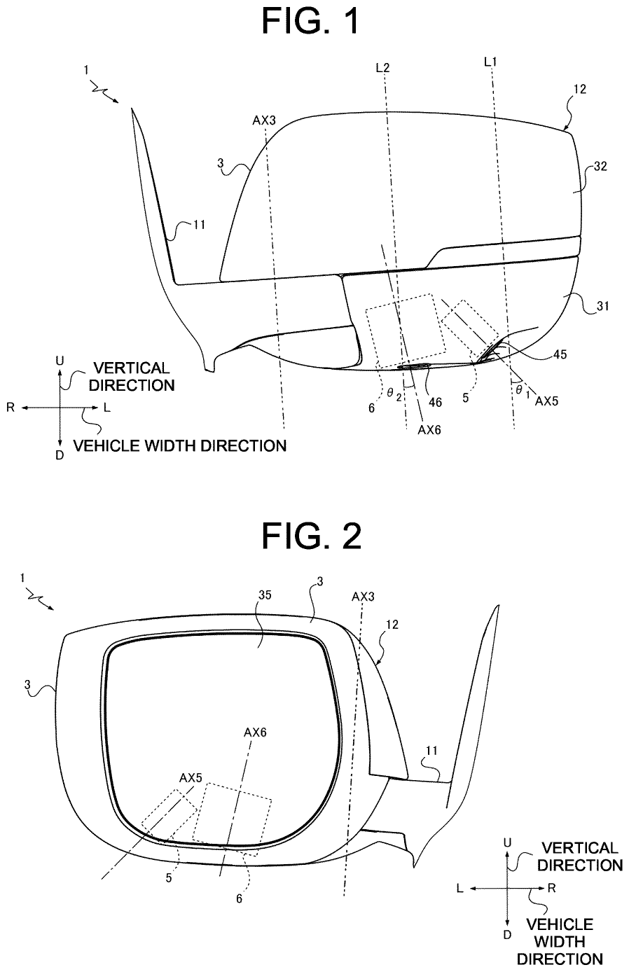

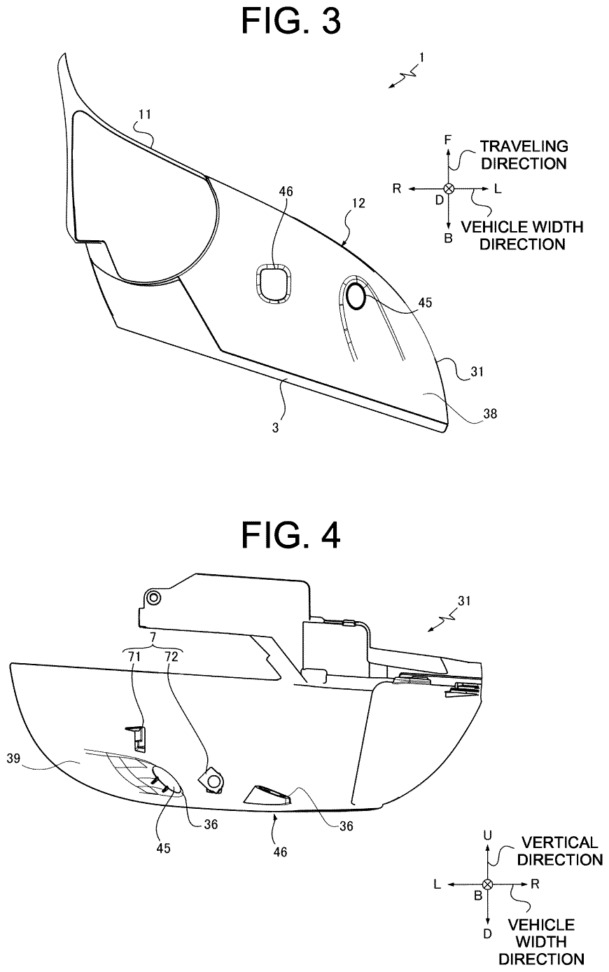

First, a mode in which a camera 5 is mounted on a door mirror 1 will be described mainly with reference to FIGS. 1 to 3. FIG. 1 is a front view of the door mirror 1, and also shows, by dotted lines, the camera 5 and a lamp 6 that are incorporated in the door mirror 1. FIG. 2 is a rear view of the door mirror 1, and also shows, by dotted lines, the camera 5 and the lamp 6 that are incorporated in the door mirror 1. FIG. 3 is a bottom view of the door mirror 1, and a lower cover 31 of the door mirror 1 has an opening for the camera 5 and an opening for the lamp 6 that are individually formed. For the door mirror 1, with respect to a straight line connecting a first position outside the door mirror 1 with a second position inside the door mirror 1, a third position closer to the first position than the second position or a direction toward the third position is referred to as outside or outer side, and a fourth position closer to the second position than the first position or a direction toward the fourth position is referred to as inside or inner side. The terms up-down direction, left-right direction, and front-rear direction are used assuming that the door mirror 1 is attached to a vehicle. The up-down direction, left-right direction, and front-rear direction are determined with respect to a driver in the vehicle. The vehicle width direction, vertical direction, traveling direction are as indicated by the coordinates in FIGS. 1 to 3 and the like.

The door mirror 1 is fastened to a door panel of a vehicle with a fastener, and provides a driver of the vehicle (not illustrated) with rear visibility (i.e., rear view or back view). The door mirror 1 typically includes a base 11, and a mirror assembly 12 that is manually or electrically rotatable around a rotation axis AX3 with respect to the base 11. The base 11 is fastened to the door panel of the vehicle with a fastener. The base 11 can be composed of a combination of a large number of parts such as a base housing, a shaft holder, and a harness guide.

The mirror assembly 12 is typically rotatably connected to the base 11 via a shaft (not illustrated). When the mirror assembly 12 is in an extended position (see FIGS. 1 and 2), a mirror 35 is positioned to face backward. When the mirror assembly 12 is in a retracted position (not illustrated), the mirror 35 is positioned to face a side surface of the vehicle. The mirror assembly 12 can be electrically controllable between the extended position and the retracted position based on the structure of the shaft. The mirror 35 can be swingable according to the operation of a mirror drive unit (not illustrated). These drive mechanisms are known in this field, and description thereof will be omitted.

The mirror assembly 12 can be assembled from a plurality of housing parts. The housing parts are made of metal or resin, and are formed by die casting or injection molding, but can also be formed by other methods. In some cases, the mirror assembly 12 includes, as housing parts, a mirror housing 3, a lower cover 31 that defines a housing space of the door mirror 1 together with the mirror housing 3, and an upper cover 32 that defines the housing space of the door mirror 1 together with the mirror housing 3 and the lower cover 31. The mirror housing 3 can function as a housing for the mirror 35, and function as a support portion of various parts such as an actuator and a harness. The lower cover 31 and the upper cover 32 can be lighter in weight than the mirror housing 3. The outer shape of these parts can be changed according to various requirements such as design requirements. The lower and upper covers are also simply referred to as housing covers without distinction.

The camera 5 and the lamp 6 are disposed in the housing space of the mirror assembly 12, for example, the housing space defined by the mirror housing 3 and the lower cover 31. The lower cover 31 has an opening 45 through which the camera 5 spatially communicates with the external space, and an opening 46 through which the lamp 6 spatially communicates with the external space. The lower cover 31 includes a shell portion 37 that has an outer surface 38 and an inner surface 39 and whose thickness is defined by the outer surface 38 and the inner surface 39. The openings 45 and 46 pass through at least the shell portion 37. While the door mirror 1 is attached to the vehicle, the openings 45 and 46 face downward in the vertical direction, that is, face a travel surface (e.g., road surface) on which the vehicle travels. Each of the openings 45 and 46 means a space that is not occupied by any object. The opening 46 for the lamp is larger in size than the opening 45 for the camera, but the present disclosure is not necessarily limited to this. Various structure portions can be provided on the outer surface 38 and the inner surface 39 of the shell portion 37. For the outer shape of the door mirror 1, the shell portion 37 has an arbitrary three-dimensional shape.

The camera 5 is used as a monitor that captures an image of an area around the vehicle to support safe driving, but can also be used for other purposes (detection of an object around the vehicle). The lamp 6 is a device that illuminates a road surface and/or the side surface of the vehicle, and can typically be a lighting lamp (e.g., foot lighting lamp) or a projection lamp. The lighting lamp can be turned on in synchronization with the opening of a door of the vehicle or the operation of the camera 5. The projection lamp can be turned on in synchronization with the opening or unlocking of a door of the vehicle or other events. The lighting lamp illuminates a wider area than the projection lamp, and thus can be considered to have lighting characteristics different from those of the projection lamp. Unlike the lighting lamp, the projection lamp may have a convex lens, and thus can be considered to have lighting characteristics different from those of the lighting lamp. Other various types of lamps can be adopted as the lamp 6. The projection lamp can project a logo or a design that is related or unrelated to the manufacturer or type of the vehicle.

As illustrated in FIG. 1, an angle θ1 (acute angle) formed by an optical axis AX5 of the camera 5 and an axis L1 parallel to the rotation axis AX3 of the mirror assembly 12 is larger than an angle θ2 (acute angle) formed by an optical axis AX6 of the lamp 6 and an axis L2 parallel to the rotation axis AX3 of the mirror assembly 12, thus making it possible to acquire an image in an area sufficiently apart from the vehicle. The same applies when the axes L1 and L2 are rephrased as axes parallel to the vertical direction.

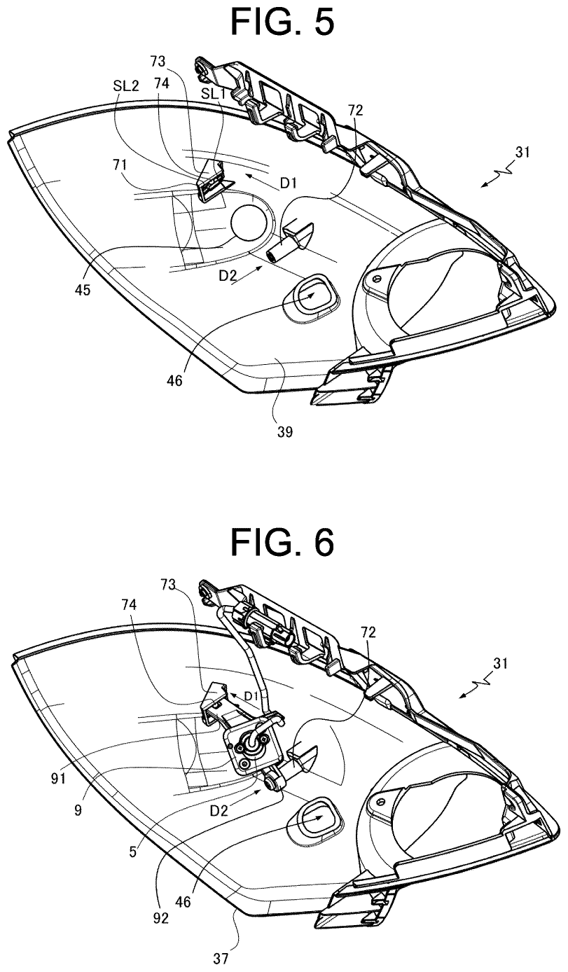

Description will be provided with reference to FIGS. 4 to 6. The camera 5 is attached to a camera attaching portion 7 (see FIG. 4) of the lower cover 31 via a bracket 9 (see FIG. 6), and receives a light flux coming through the opening 45 and acquires an image. The lower cover 31 has the camera attaching portion 7 to which the camera 5 is attached via the bracket 9. The camera attaching portion 7 has attaching portions 71 and 72, and the attaching portions 71 and 72 are disposed at different positions in the vehicle width direction and/or the vertical direction. In the illustrated example, the attaching portion 71 is located on the outer side of the opening 45 in the vehicle width direction, and the attaching portion 72 is located on the inner side of the opening 45 in the vehicle width direction; however, the positions of the attaching portions 71 and 72 can be interchanged. Advantageously, the attaching portion 71, the attaching portion 72, and the opening 45 are disposed at the apexes of a triangle that can be virtually set in a space inside the lower cover 31, promoting stable holding of the camera 5. Optimally, only a total of two attaching portions such as the attaching portions 71 and 72 are provided, promoting the efficiency of assembly of the camera 5.

The attaching portion 71 has at least one slot that is opened in a direction (first direction) into which an insertion portion 91 of the bracket 9 is inserted. In some cases, the attaching portion 71 is a frame portion 73 that defines the at least one slot, and is integrally connected to the inner surface of the lower cover 31. In the illustrated example, the frame portion 73 has a pair of side walls that are raised and protrude backward from the inner surface of the lower cover 31, and a top wall (back wall) that is farthest from the inner surface of the lower cover 31.

The attaching portion 71 can have a dividing portion 74 that divides the slot defined by the frame portion 73 into two slots SL1 and SL2. In the illustrated example, the slots SL1 and SL2 are disposed in the vehicle traveling direction. The dividing portion 74 connects the side walls of the attaching portion 71 at the intermediate height of the side walls. The attaching portion 72 is, for example, a boss as illustrated, and protrudes backward from the inner surface of the lower cover 31. The boss that is the attaching portion 72 has a hole into which an axis portion of a fastener is inserted, and a seat surface on which a fastened portion 92 is seated is formed around the hole. A structure other than the boss can also be adopted as the attaching portion 72.

The bracket 9 has the insertion portion 91 that is inserted into the at least one slot of the attaching portion 71 of the lower cover 31 in a first direction D1, and the fastened portion 92 that is fastened to the attaching portion 72 of the lower cover 31 with a fastener in a second direction D2 that is different from the first direction D1. Thus, after the bracket 9 is attached to the camera 5, it is possible to insert the insertion portion 91 of the bracket 9 into the slot of the attaching portion 71 and then dispose the fastened portion 92 of the bracket 9 on the attaching portion 72 and fasten the fastened portion 92 with a fastener. That is, it is possible to promote smooth assembly of the camera 5 to the constituent parts of the door mirror. In the illustrated example, the first direction D1 is a direction along the vehicle width direction, and the second direction D2 is a direction along the vehicle traveling direction.

In particular, by inserting the insertion portion 91 into the slot of the attaching portion 71 and disposing the fastened portion 92 on the attaching portion 72, it is possible to temporarily fix the camera 5 with the bracket 9 (also simply referred to as a camera unit). While the camera unit is temporarily fixed, the fastened portion 92 can be stably and smoothly fastened to the attaching portion 72 with a fastener. In some cases, before fastening, the camera unit can be swung depending on the degree of insertion of the insertion portion 91 into the slot of the attaching portion 71, the structure of the slot of the attaching portion 71, or the structure of an insertion end of the insertion portion 91; thus, the fastened portion 92 can be easily disposed on the attaching portion 72.

In the following, a mode in which the camera 5 is not attached to the lower cover 31 and a closing part 20 is attached to the lower cover 31 to close the opening 45 will be described. In this mode, the lower cover 31 to which a camera is to be attached can also be used as a lower cover to which no camera is to be attached, achieving lower manufacturing cost. Furthermore, it is possible to prevent the inflow of rainwater and wind through the opening 45 of the lower cover 31 and protect the internal parts (e.g., harness, lamp, and/or drive mechanism) of the door mirror 1. Needless to say, the closing part 20 may not necessarily close the opening 45 of the lower cover 31. When the opening 45 is formed on a housing cover other than the lower cover 31, the closing part 20 can be attached to the housing cover to close the opening 45. Furthermore, the opening closed by the closing part 20 may not necessarily be the opening 45 for the camera, and may be an opening for a lamp, other optical devices, a harness, or an electric wire.

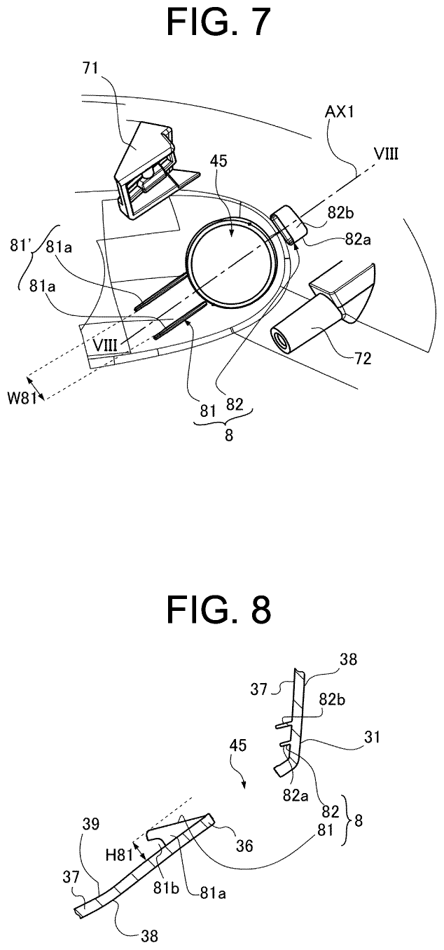

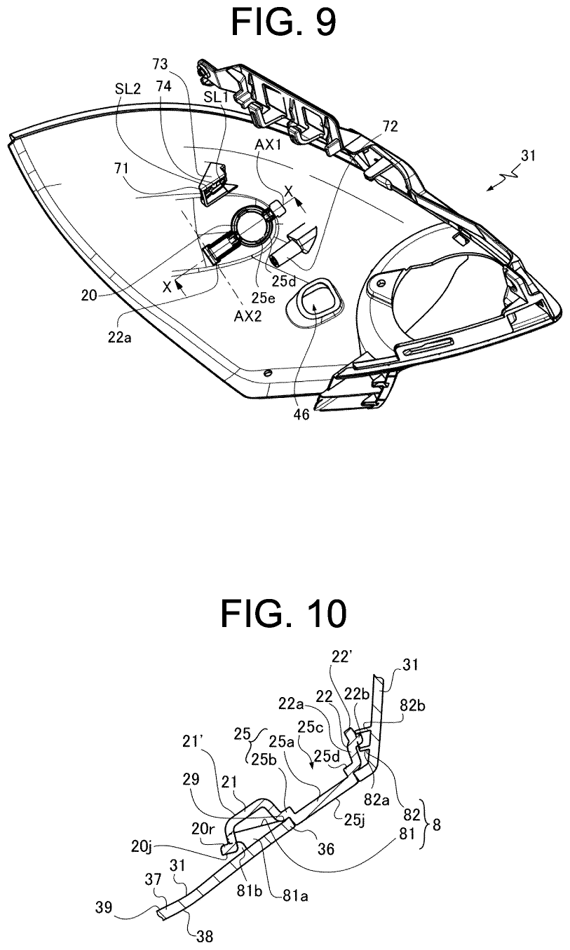

FIG. 7 is a schematic partially enlarged view of the lower cover 31, and shows a closing part attaching portion 8 to which the closing part 20 is attached. FIG. 8 is a schematic cross-sectional view of the lower cover 31 taken along the dot-dashed line VIII-VIII in FIG. 7. FIG. 9 is a schematic perspective view of the lower cover 31 while the closing part 20 is attached to the lower cover 31. FIG. 10 is a schematic cross-sectional view of the lower cover 31 taken along the dot-dashed line X-X in FIG. 9.

The lower cover 31 has the closing part attaching portion 8 to which the closing part 20 is attached. The closing part attaching portion 8 has a first attaching portion 81 and a second attaching portion 82. The first attaching portion 81 and the second attaching portion 82 are disposed on both sides of the opening 45 to sandwich the opening 45 on the same straight line. The first attaching portion 81 is located between the attaching portion 71 and the attaching portion 72 of the camera attaching portion 7, and the same applies to the second attaching portion 82. Thus, each of the camera attaching portion 7 and the closing part attaching portion 8 can be designed without being spatially limited by the other.

The first attaching portion 81 can be provided as a pivotally supporting portion 81′ that pivotally supports the closing part 20. The pivotally supporting portion 81′ includes a pair of pivotally supporting plates 81a having cutouts 81b that face the outside of the opening 45 in the radial direction. The pair of pivotally supporting plates 81a are provided parallel to each other outside the opening 45 in the radial direction to form a space with a predetermined width W81 between the pair of pivotally supporting plates 81a. The width W81 is larger than the width of a connecting portion 28 of the closing part 20 (described below), and is preferably slightly larger than the width of the connecting portion 28. Thus, it is possible to avoid interference between the pivotally supporting plates 81a and the connecting portion 28 of the closing part 20. Additionally or alternatively, the pivotally supporting plates 81a have a height H81 that is gradually reduced toward the opening 45. Thus, it is possible to avoid interference between the pivotally supporting plates 81a and the connecting portion 28 of the closing part 20 during pivotal movement of the closing part 20 as described below. While the closing part 20 is attached to the lower cover 31, the connecting portion 28 of the closing part 20 is sandwiched between the pair of pivotally supporting plates 81a. A gap between the connecting portion 28 and the lower cover 31 is at least partially closed on both sides of the connecting portion 28 by the pair of pivotally supporting plates 81a. Thus, it is possible to prevent a reverse pivotal force causing detachment of the closing part 20 from acting on the connecting portion 28 (in particular, the connecting portion 28 having a U-shape).

The second attaching portion 82 has a locking portion 82b that locks a locked portion 22b of the closing part 20 to prevent detachment of the closing part 20. For this purpose, the second attaching portion 82 can have an arbitrary shape. In the illustrated example, the second attaching portion 82 is provided as a cylinder portion 82a that at least partially receives the locked portion 22b of the closing part 20. In the cylinder portion 82a, a portion of a side wall portion (i.e., locking portion 82b) located farther from the opening 45 has a larger height than a portion of the side wall portion closer to the opening 45, ensuring a sufficient locking function. Other configurations can also be adopted as the second attaching portion 82 and/or the cylinder portion 82a.

The closing part 20 is a resin part manufactured by injection molding and thus is slightly flexible, and is slightly elastically deformable in the process of attaching the closing part 20 to the lower cover 31. The closing part 20 is a plate-shaped part whose thickness is defined by two surfaces, and has an outer surface 20j and an inner surface 20r while the closing part 20 is attached to the lower cover 31. The closing part 20 includes a closing portion 25 that is at least partially disposed in the opening 45 to close the opening 45, and a first attached portion 21 and a second attached portion 22 that are provided on both sides of the closing portion 25 to sandwich the closing portion 25 and are individually attached to the first attaching portion 81 and the second attaching portion 82 of the lower cover 31.

The present embodiment adopts the closing part 20 that closes the opening 45 of the lower cover 31 from the inside of the lower cover 31 (or the inside of the door mirror 1) (see FIGS. 9 and 10). Thus, it is possible to eliminate or reduce the risk of falling of the closing part 20. For example, even if the closing part 20 is detached for some reason (e.g., by physical impact) while the vehicle is traveling or stopped, the closing part 20 remains in the internal space of the door mirror 1, and is less likely to fall off the door mirror 1, at least as compared with the case where the opening 45 is closed from the outside of the lower cover 31. When the closing part 20 remains in the internal space of the door mirror 1, abnormality of the door mirror 1 can be detected from a sound produced while the vehicle is traveling, thus making it possible to repair the door mirror 1 and protect the internal parts of the door mirror 1 more quickly. The closing part 20 typically has a size and/or shape that does not allow the closing part 20 to close the opening 45 of the lower cover 31 from the outside of the lower cover 31 (door mirror 1).

The closing portion 25 is provided to close the opening 45. The closing portion 25 can have a sealing surface 29 that is brought into contact with an inner surface of a peripheral edge portion 36 of the shell portion 37 that defines the opening 45. The sealing surface 29 is advantageously brought into contact with the inner surface of the peripheral edge portion 36 on the entire circumference of the peripheral edge portion 36. Thus, the closing portion 25 is in close contact with the peripheral edge portion 36 without a gap, preventing the inflow of a fluid such as air or water. For this purpose, while the closing part 20 is attached to the lower cover 31, the closing part 20 may be slightly bent (outward with respect to the door mirror 1 and/or the lower cover 31). In that case, the inner surface of the peripheral edge portion 36 is pressed by the sealing surface 29, allowing the inner surface of the peripheral edge portion 36 to be in closer contact with the sealing surface 29. In the illustrated example, the opening 45 has a circular shape, the peripheral edge portion 36 is an annular portion around the opening 45, and the sealing surface 29 is also an annular surface; however, these portions can have other shapes (e.g., a rectangular shape). Furthermore, interposition of a sealing material such as an O-ring may be considered; however, in that case, variation may occur in the final position of the closing part 20 with respect to the lower cover 31, making it more difficult for a closing surface 25j of the closing part 20 to be flush with the outer surface 38 of the shell portion 37 of the lower cover 31 as described below.

The first attached portion 21 and the second attached portion 22 of the closing part 20 can be symmetrically shaped, and in that case, the common closing part 20 can be used for the door mirrors 1 on both left and right sides. For the same reason, the first attaching portion 81 and the second attaching portion 82 may also be symmetrically shaped. Advantageously, the entire closing part 20 is symmetric, but a portion of the closing part 20 unrelated to attachment of the closing part 20 to the lower cover 31 may not necessarily be symmetric.

Furthermore, the closing part 20 can be symmetric with respect to a first axis AX1 perpendicular to a direction in which the opening 45 passes through the lower cover 31 (while the closing part 20 is attached to the lower cover 31). Similarly, the first attaching portion 81 and the second attaching portion 82 can also be symmetric with respect to the first axis AX1 perpendicular to the direction in which the opening 45 passes through the lower cover 31. In FIG. 9, each of the closing part 20, the first attaching portion 81, and the second attaching portion 82 is symmetric with respect to the first axis AX1 (dot-dashed line X-X). As can be seen from FIG. 9, the first axis AX1 intersects the vehicle width direction and extends in the vehicle traveling direction, but the present disclosure is not limited to this. The camera attaching portion 7 is not provided on the first axis AX1.

The closing portion 25 has a closing plate 25a that is disposed in the opening 45, and a sealing portion 25b that protrudes from the closing plate 25a and has the sealing surface 29. The closing plate 25a is typically a disk portion as shown in the illustrated example, and has the closing surface 25j disposed on the outer surface 38 side of the shell portion 37 of the lower cover 31. The sealing portion 25b is an annular portion, and protrudes from the closing plate 25a toward the outside of the opening 45 in the radial direction. The closing plate 25a and the sealing portion 25b can be shaped as a rectangular plate and a rectangular frame, respectively. While the closing part 20 is attached to the lower cover 31, it is desirable for the closing plate 25a not to protrude outside the outer surface 38 of the shell portion 37 of the lower cover 31, and in that case, an external force is less likely to be applied to the closing part 20. Advantageously, the closing surface 25j is flush with the outer surface 38 of the shell portion 37 to form a continuous outer surface, allowing the door mirror 1 to have a better appearance.

The closing portion 25 can have a recessed portion 25c that is opened on the side (e.g., upper side) opposite to the opening 45. When the recessed portion 25c is provided inside the closing portion 25 in this manner, liquid flowing into the door mirror 1 may be collected in the recessed portion 25c. This is particularly problematic when the opening 45 is provided on the lower cover 31 and the recessed portion 25c faces upward. In this mode, a rib 25d surrounding the recessed portion 25c has at least one groove 25e that allows fluid discharge from the recessed portion 25c. More preferably, two grooves 25e are formed and symmetrically disposed (in other words, disposed in mirror symmetry with respect to the first axis AX1 (dot-dashed line X-X)). In this manner, it is possible to reliably ensure the fluid discharge function, regardless of which of the door mirrors 1 on the left and right sides the closing part 20 is attached to. For the two grooves 25e, two ribs 25d having an arc shape are formed. Each of the ribs 25d can be a portion formed by connecting the sealing portion 25b to the closing plate 25a, but the present disclosure is not limited to this.

The first attached portion 21 and the second attached portion 22 can have various shapes in relation to the first attaching portion 81 and the second attaching portion 82. Advantageously, the closing part 20 is attached to the lower cover 31 by pivotally moving the closing part 20. Thus, the closing part 20 can be attached to the lower cover 31 more quickly. In some cases, it is possible to easily ensure the bending of the closing part 20 after the closing part 20 is attached to the lower cover 31 described above. In the following, a mode in which the closing part 20 is attached to the lower cover 31 by pivotally moving the closing part 20 will be mainly described.

The first attached portion 21 is provided as a pivotally supported portion 21′ that is pivotally supported by the pivotally supporting portion 81′. The second attached portion 22 is provided as a turning portion 22′ that is turned during attachment of the closing part 20 to the lower cover 31. As described above, the pivotally supported portion 21′ and the turning portion 22′ are disposed on the first axis AX1 to sandwich the closing portion 25 and are symmetrically shaped with respect to the first axis AX1, promoting attachment of the closing part 20 to the door mirrors 1 on both left and right sides.

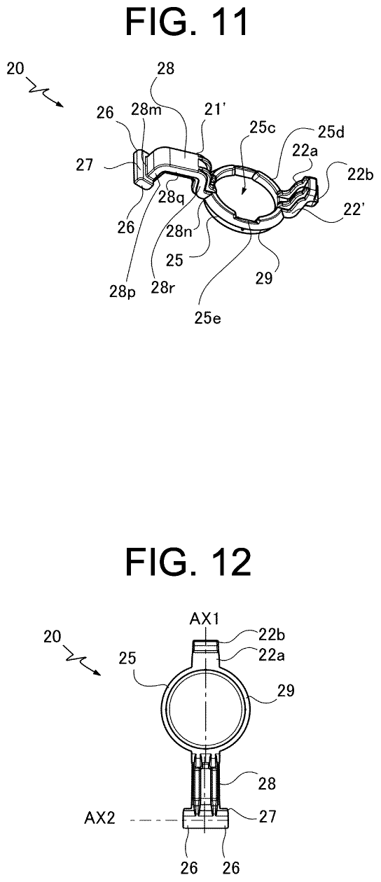

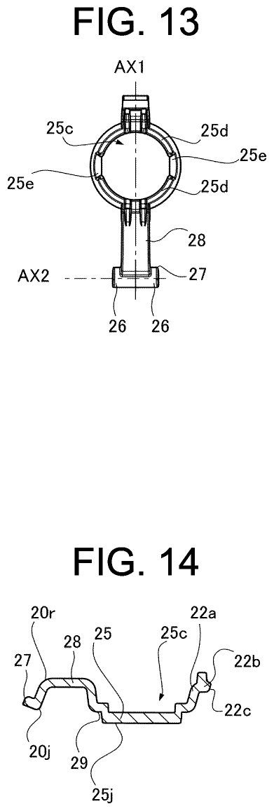

More detailed description will be provided with reference to FIGS. 11 to 14. The pivotally supported portion 21′ is shaped as a leg portion that extends away from the closing portion 25, and specifically, the pivotally supported portion 21′ includes a pivot axis portion 27, and the connecting portion 28 that extends between the closing portion 25 and the pivot axis portion 27 to connect the closing portion 25 to the pivot axis portion 27. The pivot axis portion 27 is provided on a second axis AX2 that is perpendicular to both the first axis AX1 and the direction in which the opening 45 passes through the lower cover 31, and in short, the pivot axis portion 27 is a rod-shaped portion extending along the second axis AX2. The pivot axis portion 27 includes a pair of locked ends 26 that protrude toward opposite sides on the second axis AX2, and thus has a larger width than the connecting portion 28. The second axis AX2 coincides with a pivot axis of the closing part 20. The locked ends 26 of the pivot axis portion 27 are inserted into and locked to the cutouts 81b of the pivotally supporting plates 81a, causing the pivotally supported portion 21′ (and thus the closing part 20) to be pivotally supported by the pivotally supporting portion 81′.

The connecting portion 28 has a proximal end portion 28m that is connected to the pivot axis portion 27, and a distal end portion 28n that is connected to the closing portion 25, and is bent at least at one position (two positions in the illustrated example) between the proximal end portion 28m and the distal end portion 28n to be shaped in a U-shape. When the pivotally supported portion 21′ includes the connecting portion 28 bent at least at one position, the closing part 20 is easily bent, and it is possible to provide a higher degree of flexibility in positioning of the locked portion 22b (described below) located away from the pivot axis of the closing part 20, promoting smooth attachment of the closing part 20 to the lower cover 31.

The connecting portion 28 includes a first portion 28p that extends toward the inside of the door mirror 1 away from the inner surface 39 of the shell portion 37 of the lower cover 31, a second portion 28q that extends along the inner surface 39 of the shell portion 37 toward the closing portion 25, and a third portion 28r that extends outward toward the inner surface 39 of the shell portion 37 in this order, and has a bent portion between the first portion 28p and the second portion 28q and a bent portion between the second portion 28q and the third portion 28r. When the connecting portion 28 is bent at least at one or two positions in this manner, it is possible to enable a space between the pivot axis portion 27 and the closing portion 25 to be small while obtaining desired bending characteristics, allowing the closing part 20 to be smaller in size and thus achieving the use of less resin.

The turning portion 22′ has the locked portion 22b that is locked by the locking portion 82b of the second attaching portion 82, and the locked portion 22b protrudes toward the outside of the pivot axis of the closing part 20 in the radial direction. In the illustrated example, the turning portion 22′ has a leg portion 22a that extends away from the closing portion 25, and the locked portion 22b is provided in a convex shape on an outer surface of the leg portion 22a. The locked portion 22b protrudes away from the closing portion 25 on the first axis AX1, and/or faces the outside of the opening 45 in the radial direction. The locked portion 22b has an inclined surface 22c whose inclination is gently changed, and thus can smoothly climb over the locking portion 82b.

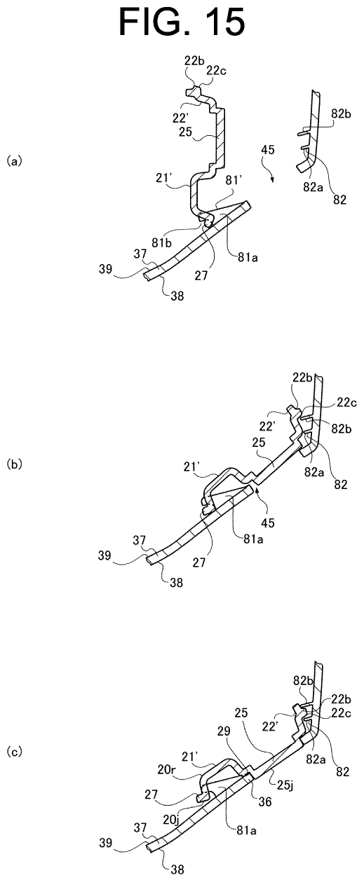

A method of attaching the closing part 20 to the lower cover 31 (the first attaching portion 81 and the second attaching portion 82) will be described with reference to FIG. 15. First, as illustrated in FIG. 15(a), the locked ends 26 of the pivot axis portion 27 of the pivotally supported portion 21′ of the closing part 20 are inserted into the cutouts 81b of the pivotally supporting plates 81a. Thus, the pivotally supported portion 21′ of the closing part 20 is pivotally supported by the pivotally supporting portion 81′. Then, as illustrated in FIG. 15(b), the closing part 20 is pivotally moved so that the closing portion 25 of the closing part 20 becomes closer to the opening 45 formed on the lower cover 31. Thus, the turning portion 22′ is turned, and the locked portion 22b of the turning portion 22′ collides with the second attaching portion 82 (in short, the locking portion 82b (the side wall portion of the cylinder portion 82a)). When the closing portion 25 of the closing part 20 is pressed into the opening 45, the closing part 20 is bent, and the locked portion 22b climbs over the locking portion 82b and is locked by the locking portion 82b, and the locked portion 22b is received in the cylinder portion 82a. Thus, as illustrated in FIG. 15(c), the closing part 20 is attached to the lower cover 31, and the opening 45 is closed by the closing portion 25.

The locked portion 22b has the inclined surface 22c, and can climb over the side wall portion of the cylinder portion 82a more smoothly, as compared with the case where the locked portion 22b does not have the inclined surface 22c. If necessary, a slit can be formed in the cylinder portion 82a to divide the cylinder portion 82a in the circumferential direction, allowing the side wall portion of the cylinder portion 82a to be flexible.

As described above, it is desirable for the sealing surface 29 to be pressed in contact with the peripheral edge portion 36. For this purpose, while the closing part 20 is attached to the lower cover 31, the closing part 20 is preferably slightly bent, but the present disclosure is not limited to this. In order to allow the door mirror 1 to have a better design appearance, the closing surface 25j of the closing portion 25 is preferably flush with the outer surface 38 of the shell portion 37 of the lower cover 31, but the present disclosure is not limited to this.

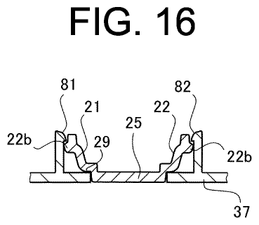

As illustrated in FIG. 16, the closing part 20 can be attached to the lower cover 31 without pivotally moving the closing part 20. In that case as well, the opening 45 is closed by the closing part 20 from the inside of the lower cover 31, achieving the same effects as described above. When the closing part 20 includes the pivotally supported portion 21′, the closing part 20 is slightly larger in size and is easier to handle by a robot hand or a human hand.

A method of manufacturing a door mirror for a vehicle is clear from the above description. Needless to say, the manufacturing method includes attaching a closing part to a housing cover to close, from an inside of the housing cover, at least one opening formed on the housing cover. In this regard, the manufacturing method can include manufacturing the housing cover by die casting or injection molding, and manufacturing the closing part by injection molding. The attaching of the closing part to the housing cover can include pivotally moving the closing part, and includes, as an option, causing a locked portion of the closing part to climb over a locking portion of the housing cover and be locked by the locking portion in the process of pivotally moving the closing part. Advantageously, the closing part is attached and fixed to the housing cover while the closing part is bent, and a sealing surface of the closing part is pressed in contact with an inner surface (inner surface of a shell portion) of the housing cover. Other features of the door mirror with a closing part are also beneficial for the manufacturing method, but not all the features will be described to avoid redundant description.

From another viewpoint, a method of manufacturing a door mirror for a vehicle includes: continuously forming a housing cover that includes at least one opening, a camera attaching portion, and a closing part attaching portion and in which the camera attaching portion and the closing part attaching portion are positioned around the at least one opening; attaching a camera, directly or via a bracket, to the camera attaching portion of a first housing cover obtained by the continuous forming of a housing cover; and attaching a closing part, from an inside of a second housing cover obtained by the continuous forming of a housing cover, to the closing part attaching portion of the second housing cover.

In the present specification, a camera and a lamp are collectively referred to as optical devices. A camera includes at least one lens and an image sensor, and the main function of the camera is to perform photoelectric conversion in pixels of the image sensor. On the other hand, a lamp includes a light source, and the main function of the lamp is to convert electric energy generated by the light source into light energy. Both devices are related to light, and can be considered as optical devices in this sense.

Based on the above disclosure, those skilled in the art can make various modifications to the embodiments and features.

### Description of Reference Numerals

1 Door mirror
20 Closing part
21 First attached portion
21′ Pivotally supported portion
22 Second attached portion
22′ Turning portion
22b Locked portion
25 Closing portion
25a Closing plate
25b Sealing portion
25c Recessed portion
25d Rib
25e Groove
25j Closing surface
26 Locked end
27 Pivot axis portion
28 Connecting portion
29 Sealing surface
36 Peripheral edge portion
37 Shell portion
45 Opening
46 Opening
81 First attaching portion
81′ Pivotally supporting portion
81a Pivotally supporting plate
81b Cutout
82 Second attaching portion
82a Cylinder portion
82b Locking portion
AX1 First axis
AX2 Second axis

1. A door mirror for a vehicle, the door mirror comprising:
a housing cover that includes a shell portion having an outer surface and an inner surface and has at least one opening passing through the shell portion; and
a closing part that closes the at least one opening from an inside of the housing cover.

2. The door mirror according to claim 1, wherein
the closing part includes a closing portion that is at least partially disposed in the at least one opening to close the at least one opening, and first and second attached portions that are provided on both sides of the closing portion to sandwich the closing portion and are individually attached to first and second attaching portions of the housing cover.

3. The door mirror according to claim 2, wherein
the first and second attached portions of the closing part are symmetrically shaped.

4. The door mirror according to claim 3, wherein
the first and second attaching portions of the housing cover are symmetrically shaped.

5. The door mirror according to claim 2, wherein
the shell portion has a peripheral edge portion that defines the at least one opening, and
the closing portion has a sealing surface that is brought into contact with an inner surface of the peripheral edge portion on an entire circumference of the peripheral edge portion.

6. The door mirror according to claim 5, wherein
the closing portion has a closing plate that is disposed in the at least one opening, and a sealing portion that protrudes from the closing plate and has the sealing surface.

7. The door mirror according to claim 2, wherein
the closing portion has a recessed portion that is opened on a side opposite to the at least one opening, and
a rib surrounding the recessed portion has at least one groove that allows fluid discharge from the recessed portion.

8. The door mirror according to claim 7, wherein
the at least one groove includes two grooves that are symmetrically disposed.

9. The door mirror according to claim 1, wherein
the closing part is attached to the housing cover by pivotally moving the closing part.

10. The door mirror according to claim 2, wherein
the first attaching portion includes a pivotally supporting portion,
the first attached portion includes a pivotally supported portion that is pivotally supported by the pivotally supporting portion,
the second attached portion includes a turning portion that is turned during attachment of the closing part to the housing cover, and
the turning portion has a locked portion that is locked by a locking portion of the second attaching portion.

11. The door mirror according to claim 10, wherein
the closing part includes a closing portion that is at least partially disposed in the at least one opening to close the at least one opening, and
the pivotally supported portion and the turning portion are disposed on a first axis to sandwich the closing portion and are symmetrically shaped with respect to the first axis.

12. The door mirror according to claim 11, wherein
the pivotally supported portion includes a pivot axis portion in which a pair of locked ends protrude toward opposite sides on a pivot axis, and a connecting portion that extends between the closing portion and the pivot axis portion to connect the closing portion to the pivot axis portion.

13. The door mirror according to claim 12, wherein
the pivotally supporting portion includes a pair of pivotally supporting plates having cutouts that face an outside of the at least one opening in a radial direction, and
the pivotally supported portion is pivotally supported by the pivotally supporting portion by insertion of the locked ends into the cutouts.

14. The door mirror according to claim 12, wherein
the connecting portion has a proximal end portion that is connected to the pivot axis portion and a distal end portion that is connected to the closing portion, and is bent at least at one position between the proximal end portion and the distal end portion.

15. The door mirror according to claim 14, wherein
the connecting portion is bent at least at two positions between the proximal end portion and the distal end portion to have a U-shape.

16. The door mirror according to claim 10, wherein
the second attaching portion has a cylinder portion that at least partially receives the locked portion.

17. The door mirror according to claim 1, wherein
the housing cover has a camera attaching portion that is positioned around the at least one opening and to which a camera or a camera unit is attached.

18. A method of manufacturing a door mirror, the method comprising
attaching a closing part to a housing cover to close, from an inside of the housing cover, at least one opening formed on the housing cover.

19. A method of manufacturing a door mirror for a vehicle, the method comprising:
continuously forming a housing cover that includes at least one opening, a camera attaching portion, and a closing part attaching portion and in which the camera attaching portion and the closing part attaching portion are positioned around the at least one opening;
attaching a camera, directly or via a bracket, to the camera attaching portion of a first housing cover obtained by the continuous forming of a housing cover; and
attaching a closing part, from an inside of a second housing cover obtained by the continuous forming of a housing cover, to the closing part attaching portion of the second housing cover.
